(19) United States
(12) Patent Application Publication
(10) Pub. No.: US 2005/0281941 A1
(43) Pub. Date: Dec. 22, 2005

(54) Method of manufacturing phosphor layer structure

(76) Inventors: Jung-Na Heo, Yongin-si (KR); Shang-Hyeun Park, Boryeong-si (KR); Tae-Won Jeong, Seoul (KR); Jong-Min Kim, Suwon-si (KR)

Correspondence Address: Robert E. Bushnell, Suite 300, 1522 K Street, N.W., Washington, DC, 20005, US

(21) Appl. No.: 11/150,147

(22) Filed: Jun. 13, 2005

(30) Foreign Application Priority Data
Jun. 17, 2004 (KR) 10-2004-0045046

(51) Int. Cl. B05D 3/00; B05D 1/18

(52) U.S. Cl. 427/65; 427/532; 427/372.2; 427/240; 427/430.1

(57) ABSTRACT

A method of manufacturing a phosphor layer structure including an improved process of forming a phosphor layer between barriers on an anode substrate includes: forming a substrate to have inner spaces divided by barriers; forming a sacrificial layer on the barriers and the inner spaces to planarize an upper surface of the substrate; forming a phosphor layer on the sacrificial layer; and removing the sacrificial layer, the phosphor layer remaining in the inner spaces previously occupied by the sacrificial layer.

### CLAIM OF PRIORITY

This application makes reference to, incorporates the same herein, and claims all benefits accruing under 35 U.S.C. §119 from an application earlier filed in the Korean Intellectual Property Office on 17 Jun. 2004 and there duly assigned Serial No. 10-2004-0045046.

### BACKGROUND OF THE INVENTION

1. Field of the Invention

The present invention relates to a method of manufacturing a phosphor layer structure for use in devices such as Field Emission Displays (FEDs), and more particularly, to a method of manufacturing a phosphor layer structure having an improved process of forming a phosphor layer between barrier ribs of an anode substrate.

2. Description of the Related Art

Recently, in the field of display devices, ongoing efforts are focused on developing flat panel displays that have large screens and require increasingly less space for installation.

Types of flat panel displays include Liquid Crystal Displays (LCDs), Plasma Display Panels (PDPs), and Field Emission Displays (FEDs). A FED displays characters and images using a backlight. In the FED, a strong electric field is supplied from a gate electrode to emitters that are arranged on a cathode electrode and spaced apart by predetermined intervals to cause the emitters to emit electrons. The electrons collide with a phosphor layer coated on the surface of an anode substrate which results in light emission. If the phosphor layer is formed uniformly, brightness, contrast, and color purity are improved.

In the FED, optical interference between different colored phosphors should be minimized. Thus, U.S. Pat. No. 6,022,652 (entitled “High Resolution Flat Panel Phosphor Screen with Tall Barriers,” published on Feb. 8, 2000) discusses an anode substrate having a barrier structure. When barriers are disposed on the anode substrate and phosphors are formed in the spaces between the barriers, the barriers can help maintain color purity and contrast.

In addition, in the above FED, the uniform application of the phosphor largely affects the brightness, contrast, and color purity.

In the above FED using an anode substrate having a barrier structure, the presence of the barriers makes it difficult to apply the phosphors between the barriers uniformly. A phosphor layer can be formed by applying a phosphor slurry by spin coating or screen printing. However, it is difficult to uniformly apply the phosphor to spaces between the barriers using these methods.

Alternatively, a process of forming a phosphor layer using a dry film-type phosphor is described below.

A substrate includes barriers that are formed as protruding stripes separated by predetermined intervals. Between the barriers, an inner space is formed, and Red (R), Green (G), and Blue (B) phosphor layers are formed in neighboring inner spaces through processes that will be described later. A phosphor layer 5R of a predetermined color, for example, red, is located on the substrate.

Then, the phosphor layer 5R is made to cover the barriers and the inner space on the substrate using a blade or a heating roller. Next, a mask having a predetermined pattern is located on the phosphor layer 5R and exposure and development processes are performed. Through these processes, all portions of the phosphor layer except where the R phosphor layer 5R will be formed are removed. Thus, the red phosphor layer 5R is formed on the substrate in a predetermined pattern.

The processes used to form the red phosphor layer 5R are repeated to form a green phosphor layer and a blue phosphor layer, thus the phosphor layer structure including the red, green, and blue phosphor layers 5R, 5G, and 5B is completed. The phosphor layers can be formed uniformly in the inner spaces between the barriers. However, since the dry film-type phosphor used is expensive, as is equipment used to perform the processes, the phosphor layer structure is expensive to manufacture. In addition, it is difficult to form the phosphor layer as a thin film.

### SUMMARY OF THE INVENTION

The present invention provides a method of manufacturing a phosphor layer structure that involves simplified processes and enables a phosphor layer to be formed on a substrate uniformly.

According to an aspect of the present invention, a method of manufacturing a phosphor layer structure is provided, the method comprising: forming a substrate to have inner spaces divided by barriers; forming a sacrificial layer on the barriers and the inner spaces to planarize an upper surface of the substrate; forming a phosphor layer on the sacrificial layer; and removing the sacrificial layer, the phosphor layer remaining in the inner spaces previously occupied by the sacrificial layer.

The sacrificial layer preferably comprises a fluid hardened by one of heat or light and removed by one of a predetermined temperature or a plasma.

The sacrificial layer is preferably formed of a thermoplastic resin.

The sacrificial layer is preferably formed of at least one material selected from the group consisting of Acrylonitrile-Butadiene—Styrene terpolymer (ABS), acetal, cellulose-based material, nylon (PA), PolyButylene Terephthalate (PBT), PolyCarbonate (PC), PolyEthylene (PE), PolyMethyl MethAcrylate (PMMA), PolyPhenylene Oxide (PPO), polypropylene, polystyrene, PolySulFone (PSF), PolyVinyl Chloride (PVC), polyStyrene-AcryloNitrile (SAN), and PolyVinyl Alcohol (PVA).

The sacrificial layer is preferably alternatively formed of a thermosetting resin.

The sacrificial layer is preferably alternatively formed of at least one material selected from the group consisting of alkyd resin, epoxy resin, melamine resin, phenol-formaldehyde resin, phenolic resin, polyester, silicones, urea-formaldehyde resin, and polyurethane.

The barrier is preferably formed to a height of 10˜200 μm.

Forming the phosphor layer preferably comprises: applying a phosphor layer onto the sacrificial layer by one of a spin coating method, a printing method, a slant application method, or a dipping method; and drying the applied phosphor layer.

The phosphor layer is preferably applied onto a part of the sacrificial layer corresponding to an upper portion of the inner spaces of the substrate.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIGS. 1A through 1D are views of processes of manufacturing a phosphor layer structure;

FIG. 2 is a partial cross-sectional view of a phosphor layer structure manufactured by the processes of FIGS. 1A through 1D;

FIGS. 3A through 3D are views of processes of manufacturing a phosphor layer structure according to an embodiment of the present invention;

FIG. 4 is an electron microscope image of a phosphor layer structure before being baked, corresponding to the process of FIG. 3A;

FIG. 5 is an electron microscope image of a plan view of the phosphor layer structure after being baked, corresponding to the process of FIG. 3D; and

FIG. 6 is an electron microscope image of a cross-section of the phosphor layer structure after being baked, corresponding to the process of FIG. 3D.

### DETAILED DESCRIPTION OF THE INVENTION

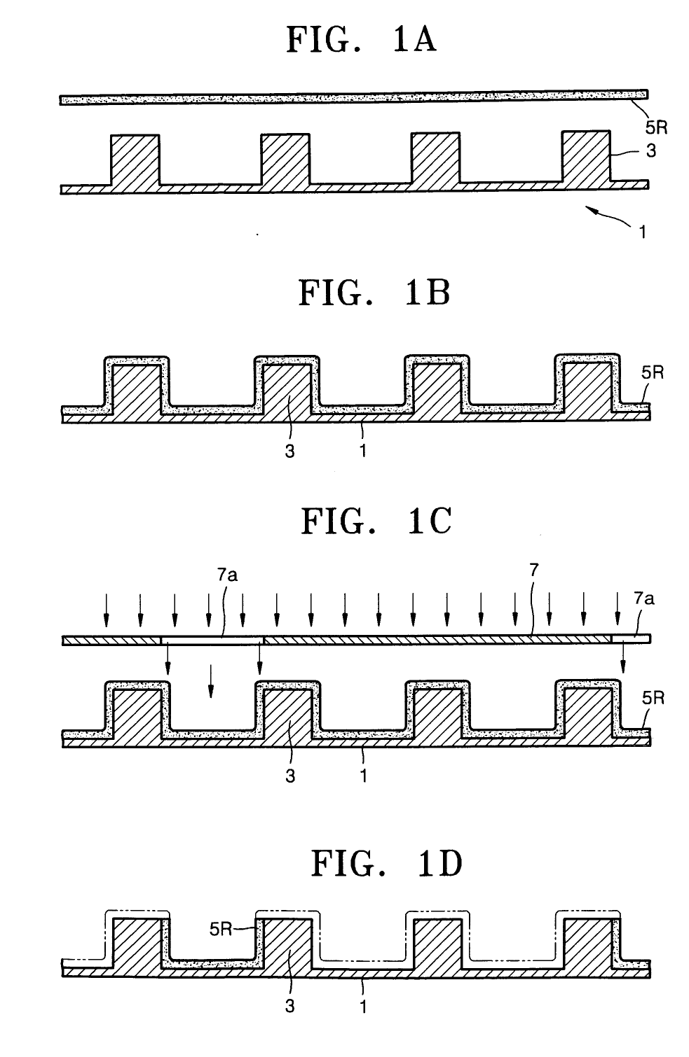

A process of forming a phosphor layer using a dry film-type phosphor is described below with reference to FIGS. 1A through 1D.

A substrate 1 includes barriers 3 that are formed as protruding stripes separated by predetermined intervals. Between the barriers 3, an inner space is formed, and Red (R), Green (G), and Blue (B) phosphor layers are formed in neighboring inner spaces through processes that will be described later. A phosphor layer 5R of a predetermined color, for example, red, is located on the substrate 1 (FIG. 1A).

Then, the phosphor layer 5R is made to cover the barriers 3 and the inner space on the substrate 1 by use of a blade or a heating roller (FIG. 1B). Next, as shown in FIG. 1C, a mask 7 having a predetermined pattern 7a is located on the phosphor layer 5R and exposure and development processes are performed. As shown in FIG. 1D, through these processes, all portions of the phosphor layer except where the R phosphor layer 5R will be formed are removed. Thus, the red phosphor layer 5R is formed on the substrate 1 in a predetermined pattern.

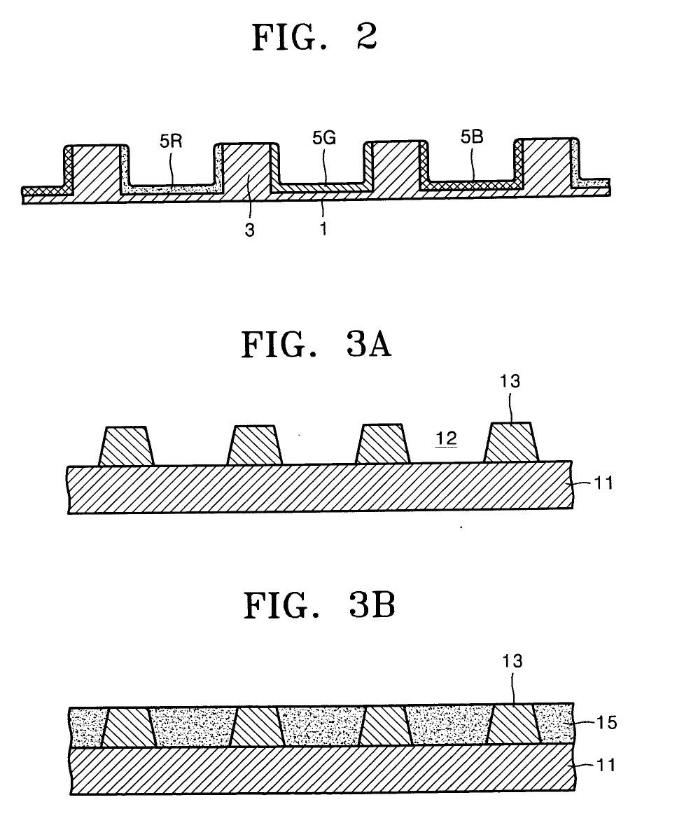

The processes used to form the red phosphor layer 5R are repeated to form a green phosphor layer and a blue phosphor layer, thus the phosphor layer structure including the red, green, and blue phosphor layers 5R, 5G, and 5B is completed, as shown in FIG. 2. The phosphor layers can be formed uniformly in the inner spaces between the barriers. However, since the dry film-type phosphor used is expensive, as is equipment used to perform the processes, the phosphor layer structure is expensive to manufacture. In addition, it is difficult to form the phosphor layer as a thin film.

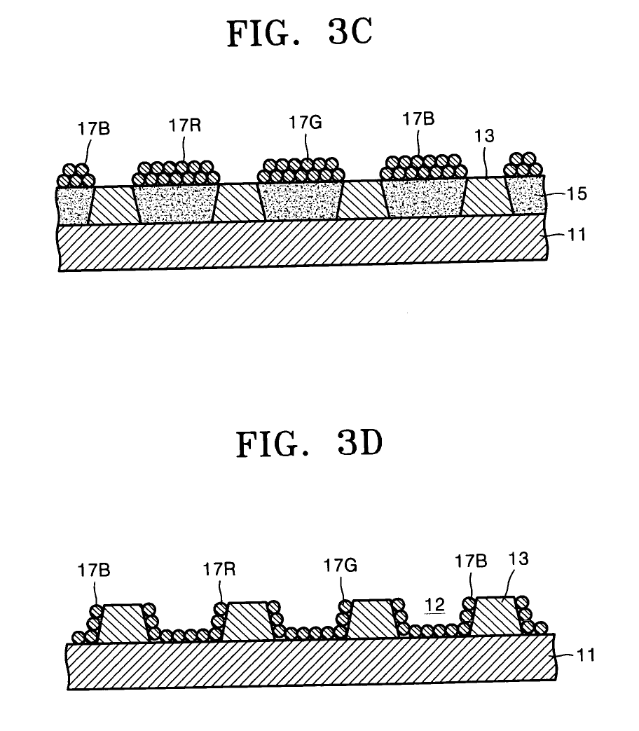

Processes of manufacturing a phosphor layer structure according to an embodiment of the present invention are described below with reference to FIGS. 3A through 3D.

As shown in FIG. 3A, a substrate 11 including inner spaces 12 that are divided by barriers 13 is prepared. The substrate 11 can be used as a display device such as a Field Emission Display (FED), in which case the substrate 11 is used as an anode and formed of a material that can transmit incident light.

The substrate 11 and the barriers 13 can be formed of the same material or of different materials. It is desirable that the barriers 13 are formed to a height of 10˜200 μm from the surface of the substrate 11 in consideration of color purity and contrast, when the phosphor layer structure is used in the display.

As shown in FIG. 3B, a sacrificial layer 15 is formed in the inner spaces 12 and the barriers 13 to planarize an upper surface of the substrate 11.

It is desirable that the sacrificial layer 15 is formed of a thermoplastic resin or a thermosetting resin that is initially fluid. Thus, when first applied, the sacrificial layer 15 flows into and fills the inner spaces 12. Later the sacrificial layer is hardened by heat or light, and finally is removed at a predetermined temperature or by plasma.

The sacrificial layer 15 can be formed of at least one material selected from a group of thermoplastic resins including Acrylonitrile-Butadiene—Styrene terpolymer (ABS), acetal, cellulose-based material, nylon (PA), PolyButylene Terephthalate (PBT), PolyCarbonate (PC), PolyEthylene (PE), PolyMethyl MethAcrylate (PMMA), PolyPhenylene Oxide (PPO), polypropylene, polystyrene, PolySulFone (PSF), PolyVinyl Chloride (PVC), polyStyrene-AcryloNitrile (SAN), and PolyVinyl Alcohol (PVA).

In addition, the sacrificial layer 15 can be formed of at least one material selected from a group of thermosetting resins including alkyd resin, epoxy resin, melamine resin, phenol-formaldehyde resin, phenolic resin, polyester, silicones, urea-formaldehyde resin, and polyurethane.

As described above, if the sacrificial layer 15 is applied on the substrate 11 in a fluid state, it fills the inner spaces 12 and the upper surface of the substrate 11 is planarized. In addition, when the sacrificial layer 15 is hardened by processes of heating or photo irradiation, the planarized upper surface becomes a solid or a gel.

Then, as shown in FIG. 3C, Red (R), Green (G), and Blue (B) phosphors 17R, 17G, and 17B are applied on the sacrificial layer 15. The phosphors 17R, 17G, and 17B can be applied by a spin coating method in which a predetermined amount of phosphor slurry is disposed on the sacrificial layer 15 and rotated, a printing method in which phosphors are printed onto the sacrificial layer 15, or a slant application method in which the substrate 11 is inclined so that the phosphors can be applied due their own weight. Alternatively, the phosphors 17R, 17G, and 17B can be formed by a dipping method in which the substrate 11 is dipped in a container having the phosphor therein. In FIG. 3C, the phosphors 17R, 17G, and 17B are formed by the spin coating method using particles that are 3˜5 μm in diameter, to form a dual-layered structure.

After the phosphors 17R, 17G, and 17B are applied, the layers are dried to complete the phosphor forming process on the sacrificial layer 15.

On the other hand, the phosphor is not applied on the entire upper surface of the substrate. It is desirable that the phosphor is selectively applied on portions of the sacrificial layer 15 corresponding to the upper portion of the inner space on the substrate 11. Also, the phosphors 17R, 17G, and 17B respectively occupy different portions according to their color, and processes for forming the phosphors are performed with respect to color.

After that, the sacrificial layer 15 is removed so that the phoshphors 17R, 17G, and 17B that are located on the sacrificial layer 15 can descend into the corresponding inner spaces 12 as shown in FIG. 3D. Then, the processes of manufacturing the phosphor layer structure of a uniform thin film are completed. Here, the sacrificial layer 15 is removed by baking or conversion to a plasma state in an air atmosphere.

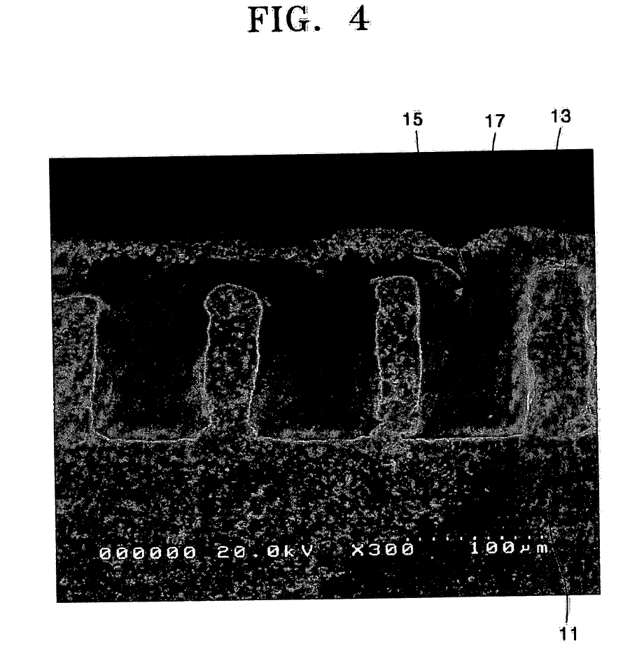

FIG. 4 is an electron microscope image showing the phosphor layer structure before it is baked, corresponding to the process shown in FIG. 3C. That is, FIG. 4 shows the sacrificial layer 15 that is formed in the inner spaces 12 and the barriers 13 after forming the barriers 13 of aluminium on a glass substrate, and the phosphor 17 formed on the sacrificial layer 15. The sacrificial layer 15 is formed of an ethyl cellulose and the phosphors are formed by the dipping method, as an example.

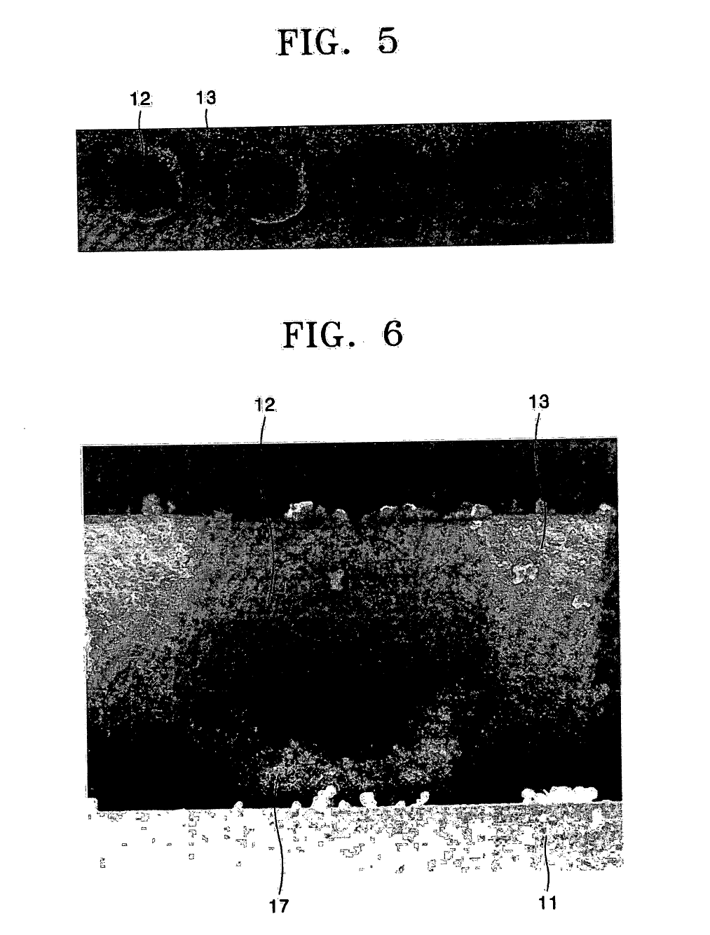

FIGS. 5 and 6 are electron microscope image showing a plane and a cross section of the phosphor layer structure after baking the structure according to the process shown in FIG. 3D. As shown in FIGS. 5 and 6, the phosphor 17 located on the sacrificial layer 15 is formed in the inner spaces 12 between the barriers when the sacrificial layer 15 is removed by baking.

According to the above method of manufacturing the phosphor layer structure of the present invention, the manufacturing processes can be simplified, and the phosphor can be applied uniformly on the substrate having the barriers. Thus, when the phosphor layer structure is manufactured by the above method and a display device such as an FED is fabricated using the phosphor layer structure, the color purity of pixels can be improved.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

1. A method of manufacturing a phosphor layer structure, comprising:
forming a substrate to have inner spaces divided by barriers;
forming a sacrificial layer on the barriers and the inner spaces to planarize an upper surface of the substrate;
forming a phosphor layer on the sacrificial layer; and
removing the sacrificial layer, the phosphor layer remaining in the inner spaces previously occupied by the sacrificial layer.

2. The method of claim 1, wherein the sacrificial layer comprises a fluid hardened by one of heat or light and removed by one of a predetermined temperature or a plasma.

3. The method of claim 2, wherein the sacrificial layer is formed of a thermoplastic resin.

4. The method of claim 3, wherein the sacrificial layer is formed of at least one material selected from the group consisting of Acrylonitrile-Butadiene—Styrene terpolymer (ABS), acetal, cellulose-based material, nylon (PA), PolyButylene Terephthalate (PBT), PolyCarbonate (PC), PolyEthylene (PE), PolyMethyl MethAcrylate (PMMA), PolyPhenylene Oxide (PPO), polypropylene, polystyrene, PolySulFone (PSF), PolyVinyl Chloride (PVC), polyStyrene-AcryloNitrile (SAN), and PolyVinyl Alcohol (PVA).

5. The method of claim 2, wherein the sacrificial layer is formed of a thermosetting resin.

6. The method of claim 5, wherein the sacrificial layer is formed of at least one material selected from the group consisting of alkyd resin, epoxy resin, melamine resin, phenol-formaldehyde resin, phenolic resin, polyester, silicones, urea-formaldehyde resin, and polyurethane.

7. The method of claim 1, wherein the barrier is formed to a height of 10˜200 μm.

8. The method of claim 1, wherein forming the phosphor layer, comprises:
applying a phosphor layer onto the sacrificial layer by one of a spin coating method, a printing method, a slant application method, or a dipping method; and
drying the applied phosphor layer.

9. The method of claim 8, wherein the phosphor layer is applied onto a part of the sacrificial layer corresponding to an upper portion of the inner spaces of the substrate.
